(19) United States
(12) Patent Application Publication
(10) Pub. No.: US 2025/0269613 A1
(43) Pub. Date: Aug. 28, 2025

(54) DEVICE AND METHOD FOR FORMING A TUBE HEAD BLANK OF A TUBE BLANK

(71) Applicant: Hoffmann Neopac AG, Thun (CH)

(72) Inventors: Michael Wagner, Oberdiessbach (CH); Kristijan Eberhard, Etziken (CH)

(73) Assignee: Hoffmann Neopac AG, Thun (CH)

(21) Appl. No.: 18/729,473

(22) PCT Filed: Sep. 25, 2023
(86) PCT No.: PCT/EP2023/076370

§ 371 Date: Jul. 16, 2024

(30) Foreign Application Priority Data
Jun. 15, 2023 (CH) CH000638/2023

(51) Int. Cl. B29C 67/00; B29D 23/20; B29L 23/20

(52) U.S. Cl. CPC B29C 67/0029; B29D 23/20; B29L 2023/20

(57) ABSTRACT

The invention relates to a device (1) for forming a tube head blank (2a) of a tube blank (2) so that a tube blank with a finished tube head (2c) is obtained. It comprises a lower tool (3) with a lower tool body (3a) and a free end (3b) which has an outer shape corresponding to an inner shape of the finished tube head, over which lower tool the tube blank can be pulled so that the tube head blank to be formed comes to lie around the free end. It further comprises an upper tool (4) which can be lowered onto the lower tool with the tube blank pulled-over. The upper tool has an upper head end piece (5) with forming jaws (5a), which together form a first recess (6) that defines an outer shape of the finished tube head. The upper head end piece comprises an actuating device (5c, 7) for opening and closing the forming jaws. The device further comprises a temperature control system for heating the upper tool to a temperature as intended. The tube head blank comes to rest in the first recess and can be formed into the finished tube head between the closed forming jaws and the free end of the lower mold.

### REFERENCE TO RELATED DOCUMENTS

This document claims priority to Swiss Patent Application No. CH000638/2023, filed Jun. 15, 2023, the entire contents of which are hereby incorporated by reference.

### FIELD OF INVENTION

The invention relates to a device and a method for forming a tube head blank of a tube blank made of plastic according to the respective independent claim.

### BACKGROUND

It is known to provide plastic tubes with a tube head. A tube blank with a tube head blank is either manufactured in one piece or the tube head blank is manufactured separately and typically extruded or compression molded or formed or ultrasonically or high-frequency welded on the tube blank. Subsequently, the resulting structure is further processed by, for example, closing the lower end of the tube blank and forming the tube head from the tube head blank. Further steps such as printing the tube body can follow.

There are a variety of processes for manufacturing such a tube, which can be made from a variety of thermoplastic materials, such as polyethylene, polyvinyl chloride, polypropylene, and so on. One challenge in the manufacture of the finished tube is the attachment and molding of the tube head, which provides the access opening for the tube contents and should be closable. This has been done using methods in which a tube head was molded on and then bonded to the tube body. These methods were cumbersome and connecting the tube head to the tube body was problematic. These methods were improved by connecting a tube head blank, which was not already formed, to the tube body and only then forming the tube head. Alternatively, the tube blank was produced in one piece with the tube head blank, e.g. as a simple cylinder, and then the tube head was molded on, thus eliminating the molding step and simplifying production. The most common variant is injecting the head (tool casting or injection molding). Both alternatives are still used. For example, in the case of the tube blank which is in one piece with the tube head blank, the procedure is to provide a device with an upper tool and a lower tool. The blank is placed on the lower tool and the upper tool is lowered onto it. By appropriately forming the upper and lower tools and heating the upper tool, the tube head blank is pressed between them and thereby heated so that it is appropriately formed. In the process, the upper tool and the lower tool can close and form the tube head blank without lowering the upper tool.

### DESCRIPTION OF THE INVENTION

The objective to be reached is to simplify the forming of tube heads from tube head blanks and to make it more flexible.

The objective is reached in a first aspect of the invention by means of a device for forming a tube head blank of a tube blank according to claim 1. In this regard, the tube head blank may be integral with the tube body of the tube blank or attached to the tube body of the tube blank. Accordingly, the device comprises a lower tool with a lower tool body and an upwardly projecting free end which has an outer shape which corresponds to an intended inner shape of the finished tube head. The tube blank can be pulled over the lower tool so that a longitudinal axis of the lower tool and a longitudinal axis of the tube blank are identical and the tube head blank to be formed comes to rest around the free end. Furthermore, the device comprises a temperature-controllable upper tool whose longitudinal axis is identical to the longitudinal axis of the lower tool. The upper tool can be moved back and forth along the longitudinal axis. The lower tool can be received with the pulled over tube blank in an upper tool body of the upper tool. The upper tool comprises an upper head end piece having at least two openable and closable forming jaws which together form a first recess which is centered with respect to the longitudinal axis, which recess defines an outer shape of the finished tube head in a closed position of the forming jaws and is diametrically larger in an open position of the forming jaws than in the closed position of the forming jaws. The upper head end further comprises an actuating device for opening and closing the forming jaws. Furthermore, the device comprises a temperature control system for heating the upper tool. The upper tool can be lowered onto the lower tool or the lower tool can be lifted into the upper tool in such a way that the tube head blank comes to rest in the first recess in the open position of the forming jaws and can be formed into the finished tube head between the closed forming jaws and the free end of the lower tool.

The objective is reached in a second aspect of the invention by means of a method for forming a tube head blank of a tube blank according to the corresponding independent method claim. The method is carried out by means of a device according to the first aspect of the invention. An advantage of the invention is that due to the use of closable and openable forming jaws, the diameter of the first recess can be varied. The fact that the diameter of the first recess is larger in the open position than in the closed position makes it easier to insert the tube head blank therein without fear of compression or generally undesirable deformations which could possibly affect the final shape of the tube head or the entire tube blank.

Another advantage of the invention is that the device can be easily adapted to different materials of the tube head blanks by adjusting the heating temperature of the upper tool.

The fact that the device is adapted for processing tube blanks with tube head blanks results in a further advantage, namely that the device does not have to be designed to take into account the risk of leakage at a seam between the tube body and the tube head during processing. This also eliminates the need for a possible leak test after forming.

### BRIEF DESCRIPTION OF THE DRAWINGS

Further embodiments, advantages and applications of the invention are apparent from the dependent claims and from the description which now follows with reference to the figures. Thereby it is shown in:

FIG. 1 sectional views of the device according to the invention showing a manufacturing sequence in partial images,

FIG. 2 sectional views of the device according to the invention from FIG. 1, showing in partial images the release of a tube blank with finished tube head,

FIG. 3 a sectional view of the upper tool of the device of FIG. 1 in a preferred embodiment during lowering of the upper tool,

FIG. 4 a sectional view of the upper tool of the device of FIG. 1 in a preferred embodiment when lifting the upper tool to release the tube blank with finished tube head,

FIG. 5 a top view of the upper tool from FIG. 4,

FIG. 6 a top view of the upper tool from FIG. 3,

FIG. 7 a side view of an exemplary tube blank with a tube head blank, and

FIG. 8 a side view of the tube blank from FIG. 7 with the tube head fully formed.

### WAYS OF CARRYING OUT THE INVENTION

As used herein, the term “tube blank” includes plastic containers in the nature of tubes for typically toothpaste, lotions, in the cosmetic, dental and pharmaceutical fields, etc., and refers to the entire tube. The tube blanks can be made from a wide variety of polymeric materials such as polyethylene, polypropylene or renewable materials or recyclates. The addition of the word “blank” in this term is merely intended to indicate that the tubes do not necessarily have to have a finished tube body, but that after the present invention, which is directed to the forming of the tube head, further steps can be taken to process the tube body. For example, steps of closing the tube base, printing the tube body, etc. may follow. However, it does not matter for the present invention whether the tube body is finished or not. In practice, however, the invention is preferably applied to an unprocessed tube blank.

Accordingly, a distinction is made here between “tube head blank” and “finished tube head” or “finished formed tube head”. The first term indicates the state before forming and the other terms the state after forming, which is shown in FIGS. 7 and 8 respectively.

In the present context, the term “temperature control” is to be understood as encompassing both heating and cooling. However, it is not absolutely necessary for a temperature control system to be able to cool. The main task of such a system as intended here is heating.

The terms “irreversibly formable” and “dimensionally stable” are to be understood here as meaning that the final shape of the tube head retains the intended shape without external influence, e.g. heat.

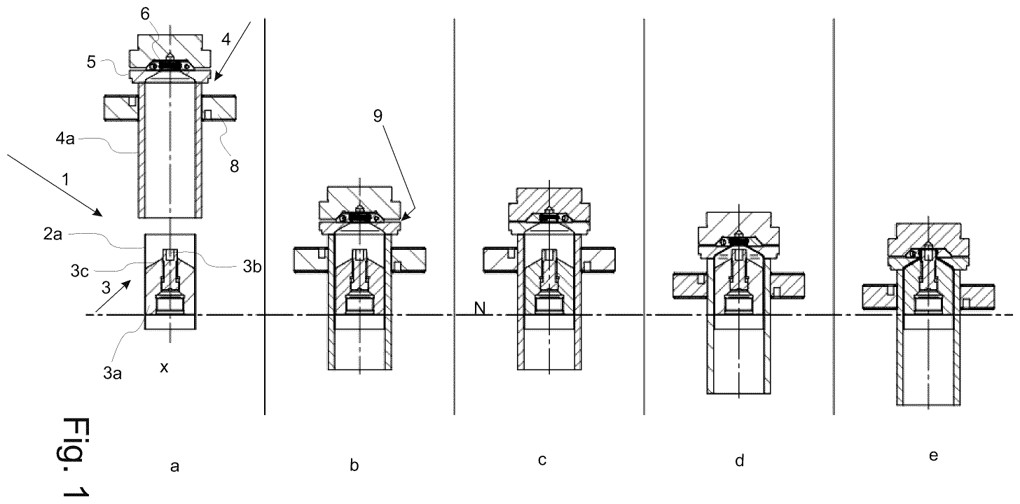

FIG. 1 shows sectional views of a device according to the invention which represent a manufacturing sequence in partial images. The horizontal dotted-dashed line N shows a reference plane to clarify the vertical position of the elements of the device in the various steps. In order to simplify the figures, the reference signs are not repeated in all figures or partial figures.

Partial FIG. 1a shows the device 1 for forming a tube head blank 2a of a tube blank 2 (FIG. 7), resulting in a tube blank with a finished tube head 2c (FIG. 8). The device comprises a lower tool 3 with a lower tool body 3a and an upwardly projecting free end 3b which has an outer shape corresponding to an intended inner shape of the finished tube head. The lower tool body is typically cylindrical. The tube blank 2 can be turned over the lower tool so that a longitudinal axis x of the lower tool and a longitudinal axis of the tube blank are identical and the tube head blank to be formed comes to rest around the free end, as shown in FIG. 1a. A shoulder 3c adjoins the free end 3b, which forms the subsequent transition between the tube head and the tube body. This also explains the fact that, in the embodiment shown, the tube head blank projects substantially beyond the free end, since this shoulder must also be taken into account in the length. In embodiments, it may be provided that a length of the free end 3b to the junction with the shoulder 3c may be varied by extending the free end more or less out of the lower tool body. This allows the fixture to be adapted to longer or shorter tube heads without having to change the entire lower tool.

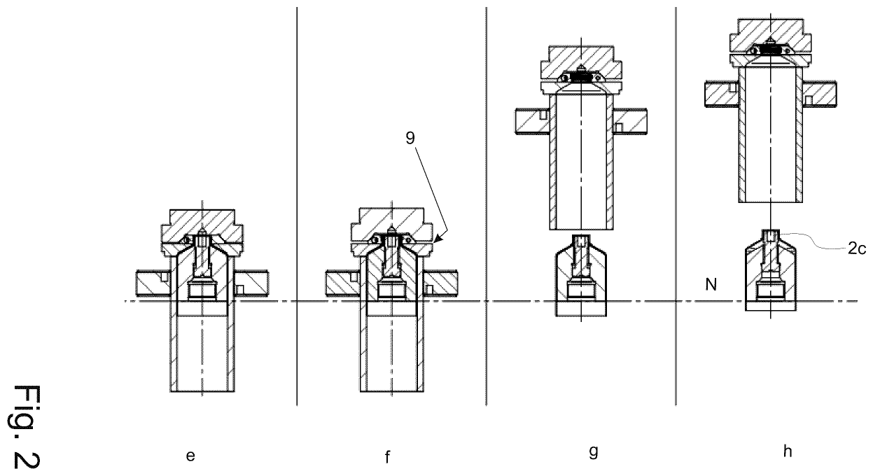

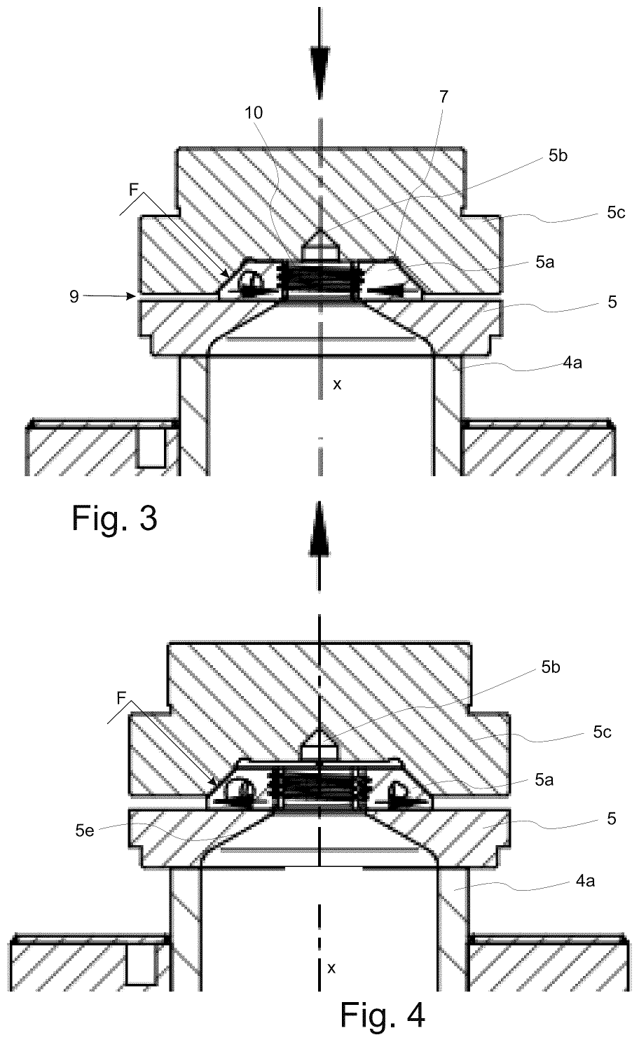

The device further comprises a temperature-controllable upper tool 4 whose longitudinal axis is identical to the longitudinal axis x of the lower tool. The upper tool can be moved back and forth along the longitudinal axis x so that the lower tool can be received with the tube blank turned up in an upper tool body 4a of the upper tool. The upper tool has an upper head end piece 5 with at least two openable and closable forming jaws 5a (FIGS. 3, 4), which together form a first recess 6 centered with respect to the longitudinal axis. In a closed position of the forming jaws, the recess defines an outer shape of the finished tube head. In an open position of the forming jaws, the recess is diametrically larger than in the closed position of the forming jaws. The upper head end further comprises an actuating device 5c, 7 (FIGS. 3, 4) for opening and closing the forming jaws.

In partial FIG. 1b, it can be seen how the upper tool has been lowered onto the lower tool and the latter is accommodated in the upper tool body. A gap 9 can be seen at the head end piece to illustrate that the forming jaws are still in the open position, wherein the operation of the forming jaws with the actuating device is explained in more detail in connection with FIGS. 3 and 4. Here, the tube head blank comes to rest in the first recess in the open position of the forming jaws.

In partial FIG. 1c, the forming jaws are closed, which is illustrated by the fact that gap 9 has disappeared from partial FIG. 1b.

In partial FIG. 1d it is visible how the upper tool has been lowered further (cf. line N) and the tube head blank has been received in recess 6. At this point, the forming process has begun. For this purpose, the device has a temperature control system (not shown) for heating the upper tool so that the thermoplastic material of the tube head blank becomes formable by cold forming.

Finally, partial FIG. 1e is intended to indicate that the upper tool remains in the lowered intended end position for a certain period of time until the forming of the tube head blank into the finished tube head is completed. This certain period of time is necessary for the thermoplastic material to become deformable to the extent that it can assume the intended shape of the tube head between the closed forming jaws and the free end of the lower tool.

FIG. 2 shows section views of the device according to the invention from FIG. 1, which illustrate in partial figures the release of the tube blank with finished tube head. The starting position in partial FIG. 2e corresponds to partial FIG. 1e.

In partial FIG. 2f, the demolding process, or in other words the release of the tube blank with finished tube head, can be seen. The forming jaws have already been opened, which is again illustrated by the gap 9.

In partial FIG. 2g, the upper tool can be seen lifting and releasing the tube blank with the finished tube head.

Partial FIG. 2h corresponds to partial FIG. 1a and shows the upper tool in its lifted initial position, with the difference that here the tube blank with finished tube head can be seen, whereas in drawing 1a the tube blank with tube head blank can be seen.

FIG. 3 shows a section view of the upper tool of the device of FIG. 1 in a preferred embodiment when the upper tool is lowered and FIG. 4 when the upper tool is lifted to release the tube blank with finished tube head. The forming jaws 5a are movable radially to the longitudinal axis x for closing and opening, so that the free end of the lower tool with the tube head blank can be enclosed by the forming jaws from the side and that in the open position of the forming jaws the free end of the lower tool with the finished tube head can be released. In FIG. 3, the closing of the forming jaws is indicated by the horizontal arrows pointing inward, while in FIG. 4, the opening of the forming jaws is indicated by the horizontal arrows pointing outward. It is preferred if exactly three forming jaws are provided. Of course, only two or more than three forming jaws can be provided.

As mentioned, an actuating device is provided for opening and closing the forming jaws. This preferably comprises a spring system with several springs 7, which are arranged in such a way that they are relaxed in the open position of the forming jaws and tensioned in the closed position of the forming jaws. In this case, the springs 7 are oriented in such a way that they press the forming jaws radially outward in the clamped state. In other words, a rest position of the forming jaws corresponds to the open position in which the springs are relaxed.

The actuating device preferably further comprises a retaining element 5c which can be moved back and forth in the x-direction. The retaining element serves to hold the forming jaws in the closed position when the springs are tensioned. The retaining element is preferably a cover, in particular a one-piece cover, which has a second recess in which the forming jaws can be at least partially received. However, the retaining element could also be designed differently to hold the springs of the spring system in the tensioned state. For example, one or more elements could be present that act on the forming jaws from the side radially towards the longitudinal axis.

In embodiments, the forming jaws each have an inclined surface F on the outside, so that in the closed position they have the shape of a truncated cone towards the top. In other words, they taper upwardly. The lid 5b has a correspondingly inclined mating surface. When the lid is lowered in the direction of the forming jaws (FIG. 3), the mating surfaces in the open position of the forming jaws cooperate with the inclined surfaces F of the forming jaws by sliding down the inclined surfaces F, which is possible due to the degree of freedom of horizontal movement of the forming jaws. This compresses the springs, allowing the forming jaws to be compressed radially towards the longitudinal axis x into the closed position. To open the forming jaws (FIG. 4), the lid can be lifted accordingly, whereby the springs push the forming jaws radially away from the longitudinal axis x and they move from the closed position to the open rest position. It is noted that the already described lowering of the upper tool does not correspond to the lowering of the lid. In other words, the lowering of the upper tool causes the forming of the tube head and the lowering of the lid causes the closing of the forming jaws. An advantage of the solution with the cooperating surfaces F and the counter-surfaces can be seen during demolding in the fact that the opening process of the forming jaws is continuous. In contrast to a solution which is also possible but not preferred, in which the forming jaws are opened abruptly, in this case the release of the forming jaws from the formed tube head takes place “gently”, so that any areas of the tube head still adhering to the inner wall of the forming jaws due to heating can detach slowly and without cracks.

A further recess 5b is provided in the lid, which is intended as an expansion space for any excess material when forming the tube head.

The mentioned gap 9 is now more visible in FIG. 3 and clarifies that during lowering the lid is lifted from the head end piece 5, whereby in the closed position of the forming jaws the lid can rest on the head end piece, which however is not mandatory and is assumed to be so in FIGS. 1 and 2 for illustration purposes. In FIG. 4, the gap is shown larger to illustrate the lifting of the lid. The head end piece itself preferably has a counter-shape to the aforementioned shoulder 3c (FIG. 1a) of the lower tool in order to form the shoulder of the tube blank between the tube head and tube body. In other words, the head end piece 5 tapers on the inside starting from the upper tool body 4a in the direction of the first recess, so that the tube head blank can be inserted into the first recess to an intended end position with increasing lowering of the upper tool while pressing the tube head blank. Advantageously, these inclined surfaces 5e additionally serve to gently help the upper edge of the normally cylindrical tube head blank to become increasingly tapered when the tube head blank is inserted into the recess 6, so that the edge is prevented from getting stuck and thereby potentially causing a kink.

In embodiments, the inner shape of the forming jaws is in each case such that, in their closed position, an intended external thread 10 can be formed in the outer shape of the tube head blank, resulting in a finished tube head with an external thread. This allows the tube to be easily closed and opened with a tube lid.

In this context, it is preferred if the forming jaws are interchangeable with alternative forming jaws whose internal shape is different. This makes it possible to achieve different external threads or generally a different external shape of the tube head for different requirements. In embodiments, it can be provided that the number of forming jaws can vary, i.e., for example, instead of a set with two forming jaws, a set with three forming jaws is used. Regardless of the number of forming jaws, it is also preferred if the device comprises several sets of exchangeable forming jaws, which can be selected at least from forming jaws of the following group: forming jaws for tube heads with external thread, forming jaws for tube heads for snap closure, forming jaws for tube heads for bounce closure, forming jaws for tube heads for shoulder closure. Other types of closures, including special closures can also be manufactured with the device. These alternatives in the number and internal shape of the forming jaws advantageously enable the device to be converted for the production of a variety of tubes with different tube heads in a simple manner by merely exchanging the forming jaws.

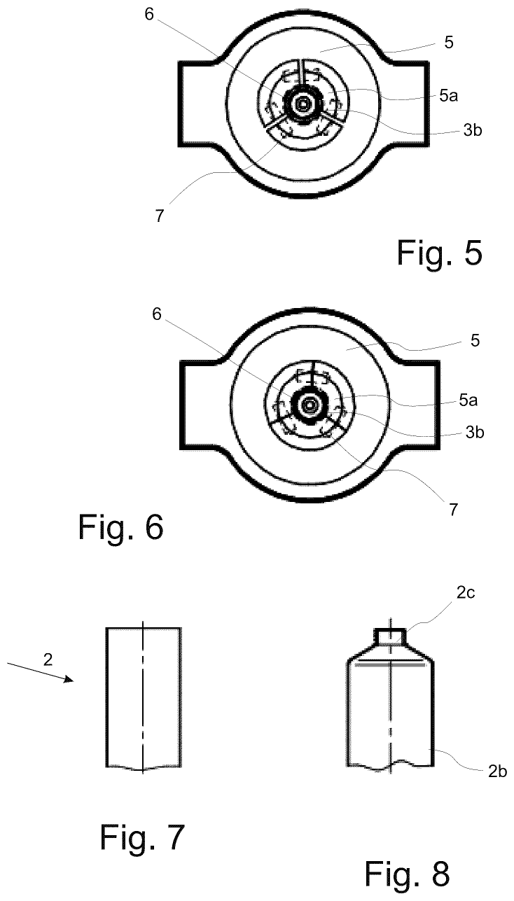

FIG. 5 shows a top view of the upper tool from FIG. 4 and FIG. 6 a top view of the upper tool from FIG. 3. The lid 5c is not shown in each case. These figures serve to illustrate the design of the forming jaws 5a in interaction with the springs 7. In the center, the recess 6 can be seen in which the tube head blank comes to rest. The free end 3b of the lower tool can also be seen. The black circular area in the figures represents the gap between the forming jaws and the free end of the lower tool, in which the tube head blank comes to rest and in which the tube head forming takes place.

In general, the device preferably comprises a first drive for translating the upper tool and/or the lower tool back and forth along the longitudinal axis (x). It is noted that, by way of example, it is described herein that the upper tool can be lowered onto the lower tool. Although this embodiment is preferred, alternatively, the lower tool could also be lifted such that it enters the upper tool body from below to the intended position. A combination of these two alternatives is also conceivable, in which the upper tool and the lower tool are moved toward each other.

It is further preferred if the first drive is not designed to rotate the upper tool and/or the lower tool about the longitudinal axis (x). This allows the first drive to be designed more simply. Due to the lateral engagement of the tube head blank by the forming jaws, an external thread can be formed by pure pressing.

In embodiments, the device comprises a second drive for translating the retaining element back and forth along the longitudinal axis x. However, it may also be provided that the first drive also performs this task.

FIG. 7 shows a side view of an exemplary tube blank with a tube head blank, and FIG. 8 shows a side view of the tube blank from FIG. 7 with the tube head fully formed.

The tube head blank is thus formed with the following steps.

a) The tube blank with the tube head blank is slipped over the lower tool so that the tube head blank comes to rest around the free end of the lower tool and the tube body rests against the lower tool body. It is possible to provide different lower tools for different tube sizes, in particular with different diameters or lengths.

b) The upper tool with open forming jaws is lowered onto the lower tool fitted with the tube blank up to a first position in which the tube head blank comes to rest in the first recess.

c) The forming jaws are closed.

d) The upper tool is lowered further to an end position in which the tube head is formed by heating the tube head blank to a specified temperature. The end position corresponds to the position in which the shoulder between the tube head and the tube body is also taken into account, i.e. until the shoulder 3c of the lower tool and the inclined counter-surface 5e are separated only by the distance corresponding to the intended thickness of the tube.

The tube head blank remains in this end position for a certain time so that the heat can act on the material and the cold forming is complete. It is preferred if the temperature control system is designed to heat the head end piece of the upper tool or the entire upper tool to a first temperature which corresponds to the intended temperature at which the tube head blank can be irreversibly formed into the finished tube head by cold forming. The upper tool can be heated either before it is lowered onto the lower tool or after it has been lowered onto the lower tool. For this purpose, the temperature control system comprises corresponding heating means which are arranged, for example, inside the upper tool.

In embodiments, the temperature control system may also be configured to heat the free end of the lower tool or the entire lower tool to a third temperature at which the tube head blank can be irreversibly formed into the finished tube head by cold forming. In other words, heating of the tube head blank can be supported by the lower tool in addition to heating by the upper tool. In such an embodiment in which the temperature control system is designed to heat the lower tool in addition to the upper tool, it is preferred if the first temperature is higher than the third temperature. Advantageously, the third temperature is only high enough to heat the tube head blank, preferably before it enters the recess, so that entry into the recess is facilitated, but it is not so high that the freely upwardly projecting tube head blank collapses before entering the recess. Heating the tube head blank beforehand shortens the time it takes for it to be formed into a dimensionally stable finished shape in the recess.

In embodiments, the temperature control system is designed to cool the head end piece of the upper tool or the entire upper tool to a second temperature so that the tube blank with the formed finished tube head can be removed from the device in a dimensionally stable manner. In addition or alternatively, the temperature control system can be designed to cool the free end of the lower tool or the entire lower tool to a fourth temperature so that the tube blank with the formed finished tube head can be removed from the device in a dimensionally stable manner.

For cooling the upper and/or lower tool, the temperature control system can have means for air cooling or liquid cooling in a known manner. This is known and will not be explained in detail here.

The device further comprises a controller for controlling the drive or drives for moving the upper tool and/or the lower tool along the longitudinal axis x, in particular for controlling the lowering depth and/or the lifting height. The controller is also designed to control the above-mentioned temperatures. For this purpose, it is connected to corresponding temperature sensors on the upper or lower tool and controls the temperature control system as a function of the sensor data. Furthermore, the length of the corresponding manufacturing sequences, e.g. dwell time during forming, etc., can be programmed into the controller. The programming or reprogramming of the above-mentioned parameters and also other parameters is advantageous so that the device can be flexibly adapted to different requirements. For example, the dwell time during forming can vary depending on the temperature and material of the tube head blank. Alternatively, the dwell time could also be controlled by cam paths.

Preferably, a valve (not shown) is arranged in the lower tool body or in the free end of the lower tool, and a compressed air line is provided which is connected to the valve, preferably extending inside the lower tool body, and is connected to an air compressor arranged outside the lower tool. The air compressor may be a conventional compressor and is preferably part of the device.

However, it need not be part of the device. The valve is closed during the forming of the tube head blank and is opened after forming by means of compressed air fed from the air compressor through the compressed air line, so that the compressed air can flow between the lower tool and the pulled-over tube blank with finished tube head. When the lower tool is removed from the tube blank or vice versa, this assists in detaching the tube blank from the lower tool. It is preferable if the valve is aligned in such a way that the outflow direction of the compressed air from the valve also causes the tube blank to be lifted from the lower tool in addition to detaching the tube blank. This is advantageous for easier removal of the tube blank from the lower tool with a corresponding gripping device.

It is preferred if the compressed air is cooled by means of the temperature control system before it is blown between the lower tool and the inverted tube blank. This supports or brings about the aforementioned cooling to the fourth temperature.

The present invention makes the forming of tube head blanks more flexible by allowing the adjustment of various parameters such as heating temperature, making different tube head materials compatible. With the options described, further degrees of freedom are made possible, such as the exchange of the forming jaws, whereby different tube head configurations can be produced based on the shape, e.g. with different closure types and different diameters.

While preferred embodiments of the invention are described in the present application, it should be clearly noted that the invention is not limited to these and may also be carried out in other ways within the scope of the following claims. Terms such as “preferred” or “in particular” or “especially” or “advantageous” or the like therefore denote only optional and exemplary embodiments.

1. A device (1) for forming a tube head blank (2a) of a tube blank (2) so that a tube blank with a finished tube head (2c) results, comprising:
a lower tool (3) with a lower tool body (3a) and an upwardly projecting free end (3b) having an outer shape which corresponds to an intended inner shape of the finished tube head, over which lower tool the tube blank can be placed so that a longitudinal axis (x) of the lower tool and a longitudinal axis of the tube blank are identical and the tube head blank to be formed comes to lie around the free end,
a temperature-controllable upper tool (4), the longitudinal axis of which is identical to the longitudinal axis (x) of the lower tool, wherein the upper tool is movable back and forth along the longitudinal axis (x), wherein the lower tool with the tube blank pulled over is receivable in an upper tool body (4a) of the upper tool, wherein the upper tool has an upper head end piece (5) with at least two openable and closable tool jaws (5a) which together form a first recess (6) centered with respect to the longitudinal axis, which recess in a closed position of the forming jaws defines an outer shape of the finished tube head and in an open position of the forming jaws is diametrically larger than in the closed position of the forming jaws, the upper head end piece further comprising an actuating device (5c, 7) for opening and closing the forming jaws, and
a temperature control system for heating the upper tool to a specified temperature,
wherein the upper tool can be lowered onto the lower tool or the lower tool can be lifted into the upper tool in such a way that the tube head blank comes to rest in the first recess in the open position of the forming jaws and can be formed into the finished tube head between the closed forming jaws and the free end of the lower tool.

2. The device of claim 1, wherein the temperature control system is designed for heating the forming jaws or the entire head end piece of the upper tool or the entire upper tool to a first temperature which corresponds to the intended temperature at which the tube head blank can be irreversibly formed into the finished tube head by cold forming, wherein the upper tool can be heated either before being lowered onto the lower tool or after being lowered onto the lower tool.

3. The device of claim 1, wherein the temperature control system is designed for cooling the forming jaws or the entire head end piece of the upper tool or the entire upper tool to a second temperature so that the tube blank with the formed finished tube head can be removed from the device in a dimensionally stable manner.

4. The device of claim 1, wherein the temperature control system is designed to heat the free end of the lower tool or the entire lower tool to a third temperature at which the tube head blank can be irreversibly formed into the finished tube head by cold forming, and/or wherein the temperature control system is designed to cool the free end of the lower tool or the entire lower tool to a fourth temperature so that the tube blank with the formed finished tube head can be removed from the device in a dimensionally stable manner.

5. The device of claim 4, wherein, in the case that the temperature control system, in addition to heating the upper tool, is also configured to heat the lower tool, the first temperature is higher than the third temperature.

6. The device of claim 1, wherein the forming jaws are movable radially to the longitudinal axis (x) for closing and opening, so that the free end of the lower tool with the tube head blank can be enclosed by the forming jaws from the side and that in the open position of the forming jaws the free end of the lower tool with the finished tube head can be released, in particular wherein exactly three forming jaws are provided.

7. The device of claim 1, wherein the actuating device comprises a spring system with a plurality of springs (7) which are arranged in such a way that they are relaxed in the open position of the forming jaws and are tensioned in the closed position of the forming jaws in such a way that they press the forming jaws radially outwards.

8. The device of claim 7, wherein the actuating device further comprises a retaining member (5c) which is movable back and forth in the x-direction and which retains the forming jaws in the closed position when the springs are tensioned, wherein the retaining member is a lid (5c) having a second recess in which the forming jaws are at least partially receivable.

9. The device of claim 7, wherein the forming jaws each have an inclined surface (F) on the outside, so that in the closed position of the forming jaws they have the shape of a truncated cone towards the top, wherein the retaining element has a correspondingly inclined counter surface, wherein, in the open position of the forming jaws, the counter-surfaces cooperate with the inclined surfaces of the forming jaws when the retaining element is lowered in the direction of the forming jaws and slide down thereon with increasing lowering, whereby the forming jaws can be compressed radially towards the longitudinal axis (x) as far as the closed position and, for opening the forming jaws, the retaining element can be lifted accordingly, whereby the springs press the forming jaws radially away from the longitudinal axis (x).

10. The device of claim 1, wherein the inner shape of the forming jaws is in each case such that, in their closed position, an intended external thread can be formed in the outer shape of the tube head blank, resulting in a finished tube head with external thread.

11. The device of claim 1, wherein the forming jaws are interchangeable with alternative forming jaws whose inner shape is different, in particular wherein the number of forming jaws can also vary, in particular wherein the device comprises a set of interchangeable forming jaws which can be selected at least from forming jaws of the following group: forming jaws for tube heads with external thread, forming jaws for tube heads for snap closure, forming jaws for tube heads for bounce closure, forming jaws for tube heads for shoulder closure.

12. The device of claim 1, wherein the head end piece (5) tapers on the inside starting from the upper tool body (4a) in the direction of the first recess, so that the tube head blank can be inserted into the first recess to a predetermined end position with increasing lowering of the upper tool, while compressing the tube head blank.

13. The device of claim 1, further comprising a first drive for displacing the upper tool and/or the lower tool translationally back and forth along the longitudinal axis (x), in particular wherein the first drive is not configured for a rotary movement of the upper tool and/or the lower tool about the longitudinal axis (x), and/or further comprising a second drive for translating the retaining element back and forth along the longitudinal axis (x).

14. The device of claim 1, wherein a valve is provided in the lower tool body or in the free end of the lower tool, a compressed air line connected to the valve and extending in particular in the interior of the lower tool body, and a compressed air compressor arranged outside the lower tool, wherein the valve is closed during the forming of the tube head blank and can be opened after the forming by means of compressed air guided from the compressed air compressor through the compressed air line, so that the compressed air can flow between the lower tool and the pulled-over tube blank with finished tube head and thus causes the tube blank to be detached from the lower tool, in particular wherein the valve is aligned in such a way that the outflow direction of the compressed air from the valve, in addition to detaching the tube blank, also assists in lifting the tube blank from the lower tool.

15. A method for forming a tube head blank of a tube blank by means of the device of claim 1, comprising the steps of:
a) Pulling the tube blank with the tube head blank over the lower tool so that the tube head blank comes to rest around the free end of the lower tool and the tube body rests against the lower tool body,
b) Lowering the upper tool with open forming jaws onto the lower tool fitted with the tube blank to a first position in which the tube head blank comes to rest in the first recess,
c) Closing the forming jaws, and
d) Further lowering the upper tool to an end position in which the tube head is formed, whereby the upper tool is heated to a specified temperature.

16. The method of claim 15, wherein after the tube head has been formed, the tube blank is detached from the lower tool by blowing compressed air between the lower tool and the pulled-over tube blank with finished tube head, thus assisting detachment of the tube blank from the lower tool.

17. The method of claim 16, wherein the compressed air is cooled by means of the temperature control system before being blown between the lower tool and the pulled-over tube blank.
